(19) United States
(12) Patent Application Publication
(10) Pub. No.: US 2022/0080578 A1
(43) Pub. Date: Mar. 17, 2022

(54) ROBOT TRANSPORT BOX

(71) Applicant: FRANKA EMIKA GMBH, München (DE)

(72) Inventor: Benjamin Loinger, München (DE)

(21) Appl. No.: 17/415,450

(22) PCT Filed: Dec. 19, 2019
(86) PCT No.: PCT/EP2019/086272

§ 371 Date: Jun. 18, 2021

(30) Foreign Application Priority Data
Dec. 21, 2018 (DE) 10 2018 133 448.6

(51) Int. Cl. B25J 9/00; B25J 5/00; B25J 19/00; B65D 85/68

(52) U.S. Cl. CPC B25J 9/0009; B65D 85/68; B25J 19/0075; B25J 5/007

(57) ABSTRACT

A robot container including a computer housing and a protective housing, wherein a plurality of rollers and a first computer housing interface are arranged on a first outer side of the computer housing and wherein a robot manipulator and a second computer housing interface are arranged on a second outer side of the computer housing opposite to the first outer side, and wherein a control unit connected to the robot manipulator is arranged in the interior of the computer housing, wherein at least one setup element for mounting the protective housing on a floor is arranged on a first outer side of the protective housing and an opening to a cavity enclosed by the protective housing and protective housing interface are arranged on a second outer side of the protective housing opposite to the first outer side, wherein the protective housing interface is reversibly connectable alternately to the first computer housing interface or to the second computer housing interface, having the following steps, so that by introducing the robot manipulator into the cavity of the protective housing and by joining the protective housing interface to the second computer housing interface, the protective housing and the computer housing form a transport container displaceable via the rollers, and so that by joining the protective housing interface to the first computer housing interface, the protective housing forms a base for the computer housing which is non-displaceable due to the at least one setup element.

### CROSS-REFERENCE TO RELATED APPLICATIONS

The present application is the U.S. National Phase of PCT/EP2019/086272, filed on Dec. 19, 2019, which claims priority to German Patent Application No. 10 2018 133448.6, filed on Dec. 21, 2018, the entire contents of which are incorporated herein by reference.

### BACKGROUND

### Field

The invention relates to a robot container for a robot manipulator, as well as a method for configuring such a robot container for the protected transportation of the robot manipulator and a method for configuring such a robot container for the mounting of the robot manipulator so it is non-displaceable in relation to a floor.

### SUMMARY

The object of the invention is to simplify the transport and the setup of a robot manipulator. The invention results from the features of the independent claims. Advantageous refinements and embodiments are the subject matter of the dependent claims.

A first aspect of the invention relates to a robot container, having a computer housing and a protective housing, wherein a plurality of rollers and a first computer housing interface are arranged on a first outer side of the computer housing and wherein a robot manipulator and a second computer housing interface are arranged on a second outer side of the computer housing opposite to the first outer side, and wherein a control unit connected to the robot manipulator is arranged in the interior of the computer housing, wherein at least one setup element for mounting the protective housing on a floor is arranged on a first outer side of the protective housing and an opening to a cavity enclosed by the protective housing and a protective housing interface are arranged on a second outer side of the protective housing opposite to the first outer side, wherein the protective housing interface is reversibly connectable alternately to the first computer housing interface or to the second computer housing interface, so that by introducing the robot manipulator into the cavity of the protective housing and by joining the protective housing to the second computer housing interface, the protective housing and the computer housing form a transport container displaceable via the rollers, and so that by joining the protective housing interface to the first computer housing interface, the protective housing interface forms a base for the computer housing which is non-displaceable due to the at least one setup element.

In particular, by introducing the manipulator into the cavity of the protective housing and by joining the protective housing interface to the second computer housing interface, the protective housing and the computer housing form a transport container, which is displaceable via the rollers and encloses the control unit and the robot manipulator.

In relation to the first case, that the protective housing and the computer housing form a transport container displaceable via the rollers, in the second case, namely that the protective housing forms a base for the computer housing which is non-displaceable due to the at least one setup element, the protective housing is pivoted around a horizontal axis by 180°. This is because in the second case the at least one setup element faces in the direction of the floor and in the first case it faces upward away from the robot container. In contrast, during the reconfiguration from the first to the second case and vice versa, the computer housing can maintain its orientation.

The rollers are advantageously arranged spaced apart from a circumference of the computer housing, that is to say arranged spaced apart from the first computer housing interface, in such a way that the rollers can be countersunk into the protective housing in the region of the protective housing interface. An externally smooth base for the robot manipulator is thus advantageously formed in the second case.

The first and the second computer housing interface and the protective housing interface are in the simplest case the respective end face of the respective computer housing or the protective housing. Furthermore, plug elements are arranged on the first and second computer housing interface and on the protective housing interface in order to enable plugging of the protective housing interface into the first or second computer housing interface.

The protective housing and/or the computer housing are advantageously each manufactured from wood, metal, or plastic.

It is an advantageous effect of the invention that the robot container can be reconfigured in a very short time from a transport box completely enclosing and thus protecting the robot manipulator and the control unit into a base for mounting the robot manipulator including control unit. Material and effort are thus advantageously saved, and the robot manipulator is rapidly movable between various locations.

According to one advantageous embodiment, the setup element has a high-friction surface.

A high-friction surface has a relatively high coefficient of adhesive friction in comparison to felt gliders (chair gliders) as are known for chairs and other pieces of furniture as a scratch protection for a parquet floor. Elastomeric plastic, hard rubber, or vulcanized rubber is preferably used.

According to a further advantageous embodiment, the protective housing and the computer housing are each cuboid and the protective housing interface and the first computer housing interface and the second computer housing interface each have a rectangular circumference.

Multiple robot containers are advantageously mountable and stackable adjacent to one another due to the cuboid design.

According to a further advantageous embodiment, the protective housing interface has an indentation and the first computer housing interface and the second computer housing interface each have an edge, wherein the indentation is arrangeable on the respective edge. Alternatively, but equivalently thereto, according to this embodiment the first computer housing interface and the second computer housing interface each have an indentation and the protective housing interface has an edge, wherein the respective indentation is arrangeable on the edge.

Edge and indentation particularly advantageously have the effect that the respective computer housing interface and the protective housing interface can be pushed past one another for a certain distance due to different radii on edge and indentation, in order to rest on one another at the end of this distance and be radially fixed and axially detachable from one another at any time by pulling apart.

According to a further advantageous embodiment, the protective housing interface is reversibly connectable alternately to the first computer housing interface or the second computer housing interface by at least one snap fitting, clamp fitting, or screw fitting.

According to a further advantageous embodiment, precisely four rollers are arranged on the computer housing, and the rollers are rotatably mounted in relation to the computer housing around an axis perpendicular to a rotational axis of the rollers.

According to a further advantageous embodiment, handles are arranged on two opposing sides of the protective housing.

The handles are preferably pivotably mounted in relation to the protective housing in such a way that the protective housing can be rotated around the axis of rotation of the respective handle, wherein the rotation is oriented in particular in such a way that the protective housing interface may be rotated by 180° around the axis of rotation of the respective handle. The rotation of the protective housing to reconfigure the robot container, as explained above, is thus advantageously facilitated.

According to a further advantageous embodiment, an axis of rotation common to the two handles extends through the center of gravity of the protective housing.

A further aspect of the invention relates to a method for configuring a robot container for the protected transportation of a robot manipulator, wherein the robot container has a computer housing and a protective housing, wherein a plurality of rollers and a first computer housing interface are arranged on a first outer side of the computer housing and wherein a robot manipulator and a second computer housing interface are arranged on a second outer side of the computer housing opposite to the first outer side, and wherein a control unit connected to the robot manipulator is arranged in the interior of the computer housing, wherein at least one setup element for mounting the protective housing on a floor is arranged on a first outer side of the protective housing and an opening to a cavity enclosed by the protective housing and a protective housing interface are arranged on a second outer side of the protective housing opposite to the first outer side, wherein the protective housing interface is reversibly connectable alternately to the first computer housing interface or to the second computer housing interface, the method including:
introducing the robot manipulator into the cavity of the protective housing; and
joining the protective housing interface to the second computer housing interface.

Advantages and preferred refinements of the proposed method result by way of an analogous and corresponding transfer of the statements made above in conjunction with the proposed robot container.

A further aspect of the invention relates to a method for configuring a robot container for mounting a robot manipulator so it is non-displaceable in relation to a floor, wherein the robot container has a computer housing and a protective housing, wherein a plurality of rollers and a first computer housing interface are arranged on a first outer side of the computer housing and wherein a robot manipulator and a second computer housing interface are arranged on a second outer side of the computer housing opposite to the first outer side, and wherein a control unit connected to the robot manipulator is arranged in the interior of the computer housing, wherein at least one setup element for mounting the protective housing on a floor is arranged on a first outer side of the protective housing and an opening to a cavity enclosed by the protective housing and a protective housing interface are arranged on a second outer side of the protective housing opposite to the first outer side, wherein the protective housing interface is reversibly connectable alternately to the first computer housing interface or to the second computer housing interface, the method including:
joining the protective housing interface to the first computer housing interface.

Advantages and preferred refinements of the proposed method result by way of an analogous and corresponding transfer of the statements made above in conjunction with the proposed robot container.

Further advantages, features, and details result from the following description in which—possibly with reference to the drawings—at least one example embodiment is described in detail. Identical, similar, and/or functionally-identical parts are provided with identical reference signs

### BRIEF DESCRIPTION OF THE DRAWINGS

In the drawings:

FIGS. 1A to 1D shows a robot container as a transparent frame model in various configuration phases according to one example embodiment of the invention;

FIGS. 2A and 2B shows a robot container in an opaque side view in various configurations according to a further example embodiment of the invention;

FIG. 3 shows a method for configuring a robot container for the protected transportation of a robot manipulator; and

FIG. 4 shows a method for configuring a robot container for mounting a robot manipulator so it is non-displaceable in relation to a floor.

The illustrations in the figures are schematic and are not to scale.

### DETAILED DESCRIPTION

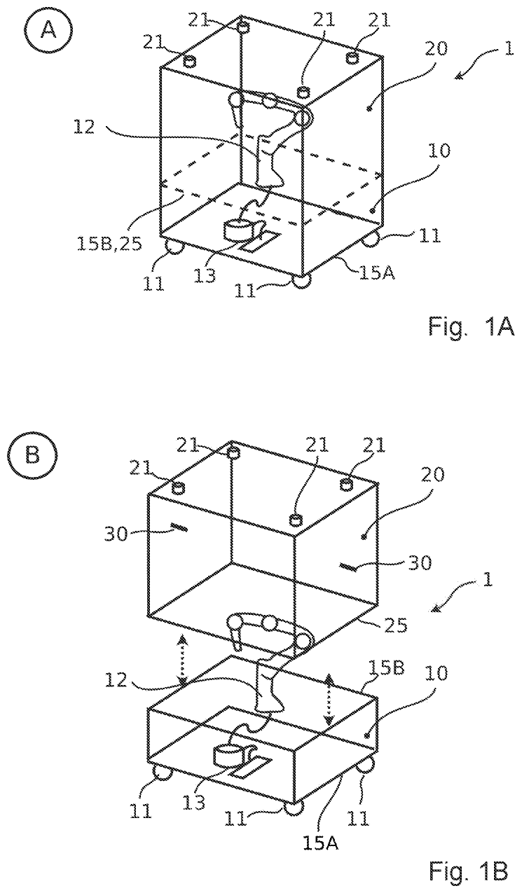

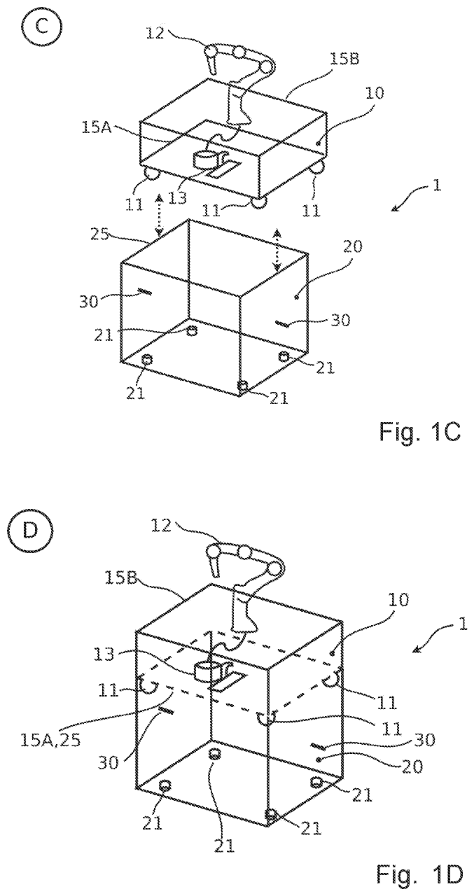

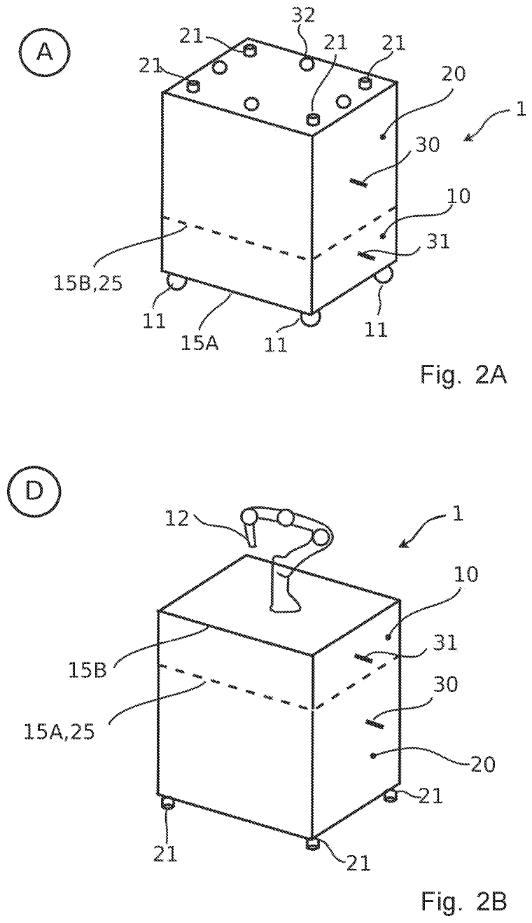

FIGS. 1A to 1D show the individual states of the robot container 1 in a wireframe model, as they occur when it is reconfigured from a state of the robot container 1, in which the robot container 1 is used as a displaceable transport container for the protected transportation of a robot manipulator 12, to a state in which it is configured as a base for a robot manipulator 12. FIGS. 2A and 2B show the starting state and end state of the robot container 1 during such a reversible reconfiguration in a three-dimensional view. The robot container 1 has a computer housing 10 and a protective housing 20. Protective housing 20 and computer housing 10 are each cuboid. The computer housing 10 encloses the control unit 13 for the robot manipulator 12. In each configuration phase, the control unit 13 remains in the computer housing 10. The protective housing 20 is used to optionally cover the robot manipulator 12 from above or to form a base for the computer housing 10. A plurality of rollers 11 and a first computer housing interface 15A are arranged on a first outer side of the computer housing 10, the lower side. On a second outer side of the computer housing 10 opposite to the first outer side, thus on the upper side of the computer housing 10, a robot manipulator 12 and a second computer housing interface 15B are arranged, wherein the control unit 13 connected to the robot manipulator 12 is arranged in the interior of the computer housing 10. Four setup elements 21 manufactured from elastomeric plastic for mounting the protective housing 20 on a floor are arranged on a first outer side of the protective housing 20 and an opening to a cavity enclosed by the protective housing 20 and a protective housing interface 25 are arranged on a second outer side of the protective housing 20 opposite to the first outer side, wherein the protective housing interface 25 is reversibly connectable alternately to the first computer housing interface 15A or to the second computer housing interface 15B. The first computer housing interface 15A and the second computer housing interface 15B each have an indentation here, so that the end face of the protective housing 20 on the protective housing interface 25 is arrangeable alternately on the end face of the computer housing 10 in the region of the first computer housing interface 15A or in the region of the second computer housing interface 15B, wherein the respective indentation secures the end faces in relation to radial slipping in each case. The term “radial” refers here to a direction which is in the joining plane of the protective housing interface 25 and the respective computer housing interface 15A, 15B. The protective housing interface 25 and the first computer housing interface 15A and the second computer housing interface 15B each have a rectangular circumference. The rollers 11 are arranged so that they can be countersunk into the interior of the protective housing 20, so that when the first computer housing interface 15A is joined together with the protective housing interface 25, the rollers 11 are no longer visible from the outside. In FIG. 1A and FIG. 2A, the protective housing 20 and the computer housing 10 form a transport container displaceable via the rollers 11 in this case. The robot manipulator 12 is arranged in the cavity formed by the protective housing 20 and is enclosed and protected by the protective housing 20. The rollers 11 rest on the floor and permit the robot container 1 to be displaced easily. In this state, the protective housing interface 25 and the second computer housing interface 15B are connected to one another. FIG. 1B shows the next step for a user to make the robot manipulator 12 accessible and mount it on a base so it is non-displaceable in relation to the floor. For this purpose, the protective housing 20 is removed from the computer housing 10, rotated by 180° around the handles 30, and placed on the floor with the setup elements 21 in front. This can be seen in FIG. 10, wherein subsequently the computer housing 10 is placed on the protective housing 20, while the robot manipulator 12 can maintain its orientation in relation to a horizontal plane. For this purpose, the first computer housing interface 15A and the protective housing interface 25 are joined to one another. The result is shown in FIG. 1D and in FIG. 2B. In addition, a further pair of handles 31 is shown in FIG. 2A and FIG. 2B, which are arranged on the computer housing 10. Furthermore, four fastening eyes 32 for possibly fixing the protective housing 20 and thus also for fixing the robot container 1 during the transport are arranged in the plane of the setup elements 21.

FIG. 3 shows a method for configuring the robot container 1 for the protected transportation of a robot manipulator 12, wherein the robot container 1 has a computer housing 10 and a protective housing 20, wherein a plurality of rollers 11 and a first computer housing interface 15A are arranged on a first outer side of the computer housing 10 and wherein the robot manipulator 12 and a second computer housing interface 15B are arranged on a second outer side of the computer housing 10 opposite to the first outer side, and wherein a control unit 13 connected to the robot manipulator 12 is arranged in the interior of the computer housing 10, wherein at least one setup element 21 for mounting the protective housing 20 on a floor is arranged on a first outer side of the protective housing 20 and an opening to a cavity enclosed by the protective housing 20 and a protective housing interface 25 are arranged on a second outer side of the protective housing 20 opposite to the first outer side, wherein the protective housing interface 25 is reversibly connectable alternately to the first computer housing interface 15A or to the second computer housing interface 15B, including the following steps: inserting S1 the robot manipulator 12 into the cavity of the protective housing 20, and joining S2 the protective housing interface 25 to the second computer housing interface 15B.

FIG. 4 shows a method for configuring a robot container 1 for mounting a robot manipulator 12 so it is non-displaceable in relation to a floor, wherein the robot container 1 has a computer housing 10 and a protective housing 20, wherein a plurality of rollers 11 and a first computer housing interface 15A are arranged on a first outer side of the computer housing 10 and wherein the robot manipulator 12 and a second computer housing interface 15B are arranged on a second outer side of the computer housing 10 opposite to the first outer side, and wherein a control unit 13 connected to the robot manipulator 12 is arranged in the interior of the computer housing 10, wherein at least one setup element 21 for mounting the protective housing 20 on a floor is arranged on a first outer side of the protective housing 20 and an opening to a cavity enclosed by the protective housing 20 and a protective housing interface 25 are arranged on a second outer side of the protective housing 20 opposite to the first outer side, wherein the protective housing interface 25 is reversibly connectable alternately to the first computer housing interface 15A or to the second computer housing interface 15B, including the following step: joining H1 the protective housing interface 25 to the first computer housing interface 15A.

Although the invention was illustrated in greater detail and explained by preferred example embodiments, the invention is not thus restricted by the disclosed examples and other variations can be derived therefrom by a person skilled in the art without leaving the scope of protection of the invention. It is therefore clear that a plurality of possible variations exist. It is also clear that embodiments mentioned by way of example actually only represent examples which are not to be interpreted in any way as restricting, for example, the scope of protection, the possible applications, or the configuration of the invention. Rather, the preceding description and the description of the figures make a person skilled in the art capable of specifically implementing the exemplary embodiments, wherein a person skilled in the art knowing the disclosed concept of the invention can perform a variety of changes, for example with respect to the function or the arrangement of individual elements mentioned in one example embodiment, without leaving the scope of protection, which is defined by the claims and the legal equivalents thereto, such as more extensive explanations in the description.

### LIST OF REFERENCE NUMERALS

1 robot container
10 computer housing
11 rollers
12 robot manipulator
13 control unit
15A first computer housing interface
15B second computer housing interface
20 protective housing
21 setup element
25 protective housing interface
30 handles
31 handles
32 fastening eye
S1 introducing
S2 joining
H1 joining

1. A robot container including:
a computer housing; and
a protective housing,
wherein a plurality of rollers and a first computer housing interface are arranged on a first outer side of the computer housing and wherein a robot manipulator and a second computer housing interface are arranged on a second outer side of the computer housing opposite to the first outer side, and wherein a control unit connected to the robot manipulator is arranged in the interior of the computer housing,
wherein at least one setup element for mounting the protective housing on a floor is arranged on a first outer side of the protective housing and an opening to a cavity enclosed by the protective housing and a protective housing interface are arranged on a second outer side of the protective housing opposite to the first outer side, wherein the protective housing interface is reversibly connectable alternately to the first computer housing interface or to the second computer housing interface.

2. The robot container as claimed in claim 1, wherein the setup element has a high-friction surface.

3. The robot container as claimed in claim 1, wherein the protective housing and the computer housing are each cuboid, and the protective housing interface, and the first computer housing interface, and the second computer housing interface each have a rectangular circumference.

4. The robot container as claimed in claim 1, wherein the protective housing interface has an indentation, and the first computer housing interface and the second computer housing interface each have an edge, wherein the indentation is arrangeable on the respective edge, or
wherein the first computer housing interface and the second computer housing interface each have an indentation and the protective housing interface has an edge, wherein the respective indentation is arrangeable on the edge.

5. The robot container as claimed in claim 1, wherein the protective housing interface is reversibly connectable alternately to the first computer housing interface or to the second computer housing interface by at least one of a snap fitting, clamp fitting, or screw fitting.

6. The robot container as claimed in claim 1, wherein precisely four rollers are arranged on the computer housing, and the rollers are rotatably mounted in relation to the computer housing around an axis perpendicular to an axis of rotation of the rollers.

7. The robot container as claimed in claim 1, wherein handles are arranged on two opposing sides of the protective housing.

8. The robot container as claimed in claim 7, wherein an axis of rotation common to the two handles extends through a center of gravity of the protective housing.

9. A method of configuring a robot container for protected transportation of a robot manipulator, wherein the robot container has a computer housing and a protective housing, wherein a plurality of rollers and a first computer housing interface are arranged on a first outer side of the computer housing and wherein a robot manipulator and a second computer housing interface are arranged on a second outer side of the computer housing opposite to the first outer side, and wherein a control unit connected to the robot manipulator is arranged in the interior of the computer housing,
wherein at least one setup element for mounting the protective housing on a floor is arranged on a first outer side of the protective housing and an opening to a cavity enclosed by the protective housing and protective housing interface are arranged on a second outer side of the protective housing opposite to the first outer side,
wherein the protective housing interface is reversibly connectable alternately to the first computer housing interface or to the second computer housing interface, the method comprising:
introducing the robot manipulator into the cavity of the protective housing; and
joining the protective housing interface to the second computer housing interface.

10. A method of configuring a robot container for the protected transportation of a robot manipulator, wherein the robot container has a computer housing and a protective housing, wherein a plurality of rollers and a first computer housing interface are arranged on a first outer side of the computer housing and wherein a robot manipulator and a second computer housing interface are arranged on a second outer side of the computer housing opposite to the first outer side, and wherein a control unit connected to the robot manipulator is arranged in the interior of the computer housing,
wherein at least one setup element for mounting the protective housing on a floor is arranged on a first outer side of the protective housing and an opening to a cavity enclosed by the protective housing and protective housing interface are arranged on a second outer side of the protective housing opposite to the first outer side, wherein the protective housing interface is reversibly connectable alternately to the first computer housing interface or to the second computer housing interface, the method comprising:
joining the protective housing interface to the first computer housing interface.
